(19) United States
(12) Patent Application Publication
(10) Pub. No.: US 2007/0258472 A1
(43) Pub. Date: Nov. 8, 2007

(54) System and Method for Initiating Auxiliary Communication Interfaces Via a Membership-Based Network

(76) Inventor: Carl Petter Engelbert Eklund, Helsinki (FI)

Correspondence Address: Hollingsworth & Funk, 8009 34th Avenue South, Suite 125, Minnerapolis, MN, 55425, US

(21) Appl. No.: 11/661,251

(22) PCT Filed: Sep. 6, 2004
(86) PCT No.: PCT/IB04/02896

§ 371 Date: Feb. 26, 2007

(51) Int. Cl. H04L 12/56

(52) U.S. Cl. 370/401

(57) ABSTRACT

A system, apparatus and method for utilizing a first communication interface(s) to initiate communications via a second communication interface(s). Auxiliary communication information (104A) is communicated from an initiating device (100) to a target device(s) (110) via a first membership-based communication interface (112). In response to the auxiliary communication information (104A), an auxiliary communication module is activated at the target device (110) for communication via a second (over-the-air) OTA communication interface (116). The target device (110) may then communicate with the initiating device (100) and/or other devices (120) via the second OTA communication interface (116).

### FIELD OF THE INVENTION

This invention relates in general to wireless communications, and more particularly to a system, method and apparatus for utilizing a first communication interface(s) to initiate communications via a second communication interface(s).

### BACKGROUND OF THE INVENTION

The proliferation of wireless communication devices evidences society's desire to be mobile and free of tethered use of computing and communication devices. The advent of the mobile phone and other wireless communication handsets has allowed users to communicate with one another while on the move. Cellular networks and other infrastructure-based networks allow such users to communicate with one another whether the users are within meters of one another, or on separate continents. When a user has his/her wireless communication device powered on, the device is typically in a “ready” state where it can receive calls at any time.

Wireless communications have also proved extremely valuable in non-infrastructure-based communications, such as in proximity networking environments. For example, computing systems may be wirelessly networked, such as with Wireless Local Area Networks (WLANs). Other short-range wireless communications are also becoming increasingly popular, such as communications via Bluetooth. With such short-range wireless communications, a wireless access point(s) is often utilized to coordinate the communications between devices within the transmission range of the wireless access point.

Short-range wireless communications such as WLAN and Bluetooth differ from infrastructure-based communications such as cellular communications in a number of ways. Cellular communications typically involve costs to the user, whether based on time usage, data transmission quantity, or the like. WLAN and Bluetooth, on the other hand, generally do not result in direct charges to the user based on time of use or transmission volumes. Further, short-range wireless communications may be controlled more closely to avoid network congestion problems. For example, two mobile device users engaged in a gaming session over a Bluetooth connection may avoid application delays that could otherwise adversely affect the session if conducted over a congestion-susceptible large-scale network. For these and other reasons, it is often desirable to communicate over short-range wireless networks rather than over large-scale networks such as cellular networks (which may implicate data networks such as the Internet, etc.).

To address such issues, mobile communication devices such as mobile phones that can communicate over cellular and other infrastructure-based networks are increasingly being equipped with auxiliary communication interfaces. For example, a mobile phone capable of communicating over a cellular network may be equipped with a Bluetooth and/or WLAN transceiver to allow communications via Bluetooth, WLAN, or other short-range wireless interface instead of, or in addition to, communication via the infiastructure-based communication interface. This provides users with flexibility in the manner of communicating with other users, as well as provides cost-effective communication alternatives.

However, some communication devices such as mobile devices are by nature limited devices compared to fixed and/or wired communication counterparts. For example, a mobile phone is intended to be a small, convenient communication tool that can be carried by users, and notwithstanding the obvious benefits of such devices, mobile devices do not share the screen size, memory capabilities, or power considerations as fixed computing/communication devices. Power consumption is of particular interest in mobile device design, as battery size and discharge characteristics (e.g., talk time, standby time, etc.) impact the convenience and usefulness of such mobile devices.

Mobile communication devices capable of infrastructure-based communications such as mobile phones may therefore be greatly enhanced by including one or more short-range wireless communications interfaces. However, each of these additional communications interfaces consumes valuable battery power, as such auxiliary communications interfaces may remain in a “listening” or paging mode, i.e., powered on and available for communicating at any time that the device itself is powered on. Thus, when such auxiliary communications interfaces are not actually in use, the circuitry associated therewith needlessly consumes valuable battery life.

A conventional manner for addressing such a problem is to provide the user with the ability to manually turn on an auxiliary communication module when prepared to use it. This solution, however, is not particularly convenient, and does not address the situation where the user's device is targeted for auxiliary communication initiated from another device. In other words, if the user has turned off his/her Bluetooth module, another user cannot initiate communications with that user via a Bluetooth connection.

Accordingly, there is a need in the wireless communication industry for a manner of conserving power on communication devices, while allowing for flexibility in the particular communication interface(s) that is to be utilized. A further need exists for a manner of providing the ability to selectively redirect communications from a first communication interface to a more desirable communication interface depending on the situation. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for utilizing a membership-based communication interface(s) to initiate communications via a second communication interface(s). The present invention can thus provide infrastructure-assisted initiation of proximity or other auxiliary networking.

In accordance with one embodiment of the present invention, a method for communicating between devices is provided. The method includes communicating auxiliary communication information from an initiating device to a target device(s) via a membership-based communication interface. In response to the auxiliary communication information, an auxiliary communication module is activated at the target device for communication via a second over-the-air (OTA) communication interface. In accordance with another embodiment, the method includes communicating the auxiliary communication information via a first communication mode of an membership-based communication interface, where an auxiliary communication mode is activated at the target device in response to the auxiliary communication information, where the target device then communicates via the auxiliary communication mode of the OTA communication interface.

According to more particular embodiments of such a method, the target device may then communicate with the initiating device and/or other devices via the second OTA communication interface. The membership-based communication interface may include, for example, a cellular network interface such as is used for mobile telephony, or other “default” communication interface that typically remains powered on and ready for communicating. The membership-based communications interface may include a darknet interface. The second OTA communication interface may include, for example, Bluetooth, WLAN, or other short-range and/or proximity network interfaces. In one embodiment, the auxiliary communication information includes instructions to the target device to turn on one or more auxiliary communication modules, or may include an invitation to the target device to initiate communications via a particular auxiliary communication interface(s).

In accordance with yet other particular embodiments of such a method, communicating the auxiliary communication information from the initiating device may be effected in a variety of manners. For example, parameters may be included in the auxiliary communication information. The parameters may include address information, location information, timing information, radio technology identification information, radio channel information, timeout information, security and authentication information, etc. Policies may also be applied at the target device to determine whether and how such auxiliary communication will be effected.

In accordance with another embodiment of the invention, a method is provided for facilitating network communications via a mobile device. The method includes receiving at least one message at the mobile device via a membership-based communication interface, where the message includes proximity communication information. The proximity communication information is identified at the mobile device, which in response enables a wireless proximity communication interface(s) for communication. The mobile device can then communicate wirelessly with at least one other communication device via the enabled wireless proximity communication interface.

In accordance with another embodiment of the invention, a communication device for communicating over-the-air (OTA) is provided. The communication device includes at least one default radio communication module configured for communication via a membership-based communication interface. The communication device also includes at least one auxiliary radio communication module capable of effecting second wireless communication via a respective auxiliary radio communication interface. A processing module is configured to receive auxiliary communication information via the membership-based communication interface, and to activate the auxiliary radio communication module identified by the auxiliary communication information for communication via the respective auxiliary radio communication interface.

In accordance with another embodiment of the invention, a system is provided for communicating information between devices. The system includes a an initiating communication device and a recipient communication device. The recipient communication device is coupled to communicate over a membership-based communications interface with the initiating communication device to receive auxiliary communication information from the initiating communication device. The recipient communication device includes a first communication module configured for first communication via the membership-based communications interface. At least one auxiliary communication mode is included that is capable of effecting second wireless communication. A processing module is configured to receive the auxiliary communication information via the first communication module over the membership-based communications interface, and to activate the auxiliary communication mode identified by the auxiliary communication information for communication via the second wireless communication.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of a system, apparatus, and method in accordance with the invention.

### BRIEF DESCRIPTION OF THE DRAWINGS

The invention is described in connection with the embodiments illustrated in the following diagrams.

FIG. 1 is a block diagram illustrating an exemplary embodiment for providing infrastructure-assisted initiation of auxiliary network communications in accordance with the present invention;

FIG. 2A is a block diagram illustrating a more particular embodiment of default interface-assisted initiation of auxiliary network communications in accordance with the present invention;

FIG. 2B is a block diagram illustrating a more particular embodiment of default interface-assisted initiation of auxiliary network communications in accordance with the present invention;

FIG. 3 is a block diagram generally illustrating one embodiment of a target peer device capable of communicating via a first communication interface to activate one or more auxiliary communication interfaces in accordance with the present invention;

FIG. 4 is a flow diagram illustrating a representative method for initiating proximity or auxiliary networking communications via a primary and/or infrastructure-assisted connection in accordance with one embodiment of the invention;

FIG. 5 is a flow diagram illustrating another exemplary method for initiating auxiliary radio communications via a primary/default radio interface;

FIG. 6 is a flow diagram illustrating a representative method for initiating proximity or auxiliary networking communications at a target device in accordance with one embodiment of the invention;

FIG. 7 is a flow diagram illustrating a representative method for initiating auxiliary radio communications via a primary/default radio interface and utilizing policies and/or parameters in accordance with one embodiment of the present invention; and

FIG. 8 illustrates a block diagram of a representative mobile device employing principles of the present invention.

### DETAILED DESCRIPTION OF EMBODIMENTS OF THE INVENTION

In the following description of various exemplary embodiments, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

A “darknet” generally refers to a peer-to-peer network that allows the members of the darknet to share information in a manner that preserves the confidentiality of the information that is shared, as well as potentially protect the privacy of the peers. Darknets may be used to build secure virtual corporate or other networks, and/or to share content between groups of people with some level of mutual trust. Users often join darknets to obtain access to content or services. While the present invention is applicable using any member-based network where information may be provided between some or all of the trusted members of the network, the present invention is described in terms of use in connection with a darknet.

Currently, a problem associated with the establishment of ad-hoc networks is that there may be little, if any, incentive for a device user to configure his/her terminal to serve as a relay in the ad-hoc network. Any incentive is diminished if resources such as power, memory, or the like, are consumed for the benefit of unknown parties. Determining when an ad-hoc network may be established is also problematic. Valuable terminal resources may be unnecessarily consumed where attempts are made to form an ad-hoc network under circumstances that do not allow the ad-hoc network to be established.

The present invention provides device users with a manner of automatically establishing ad-hoc networks without the involvement of a network operator. It allows users to limit participation of his/her equipment in the ad-hoc network to cases where a concrete benefit is perceived by the user through the value received by participating in the darknet. The topology of the ad-hoc network is hidden from the network operator, and the network operator's mobile network capacity increases as load is transferred to the ad-hoc network. These and a variety of other advantages are provided by the present invention.

Generally, the present invention provides a system, apparatus and method for facilitating communication between communication devices. Information is communicated among a plurality of device/terminal users via a member-based network such as a darknet. Such information may include, for example, member location information, device capabilities, available device resources such as battery life, infrastructure connection speed, etc. When a member device (i.e., darknet node) determines from this information that there is a possibility to form a proximity ad-hoc network or a multi-hop ad-hoc network, signaling to establish the ad-hoc network is automatically initiated. If successful, the ad-hoc network is formed, and may be taken into account when routing packets in the darknet.

As an example, an initiating device may send a message to a target device via a darknet, such as a Freenet peer-to-peer network. Freenet is a decentralized peer-to-peer network that allows anonymous data storage and retrieval. The target device, therefore, may send the message using a Freenet message board or email client. The target device receives the message, and in response powers on, or otherwise activates or enables for communication, its WLAN module. The target device can then “listen” or otherwise remain prepared for communication with the initiating device via the WLAN, or may itself initiate the communication with the initiating device via the WLAN. In this manner, a first communication channel (e.g., Freenet) is used to cause the target device to activate a second communication channel (e.g., WLAN, Bluetooth, etc.) for subsequent communication with the initiating device. This example is merely representative of a manner in which the present invention may be utilized, and various embodiments are described in greater detail below.

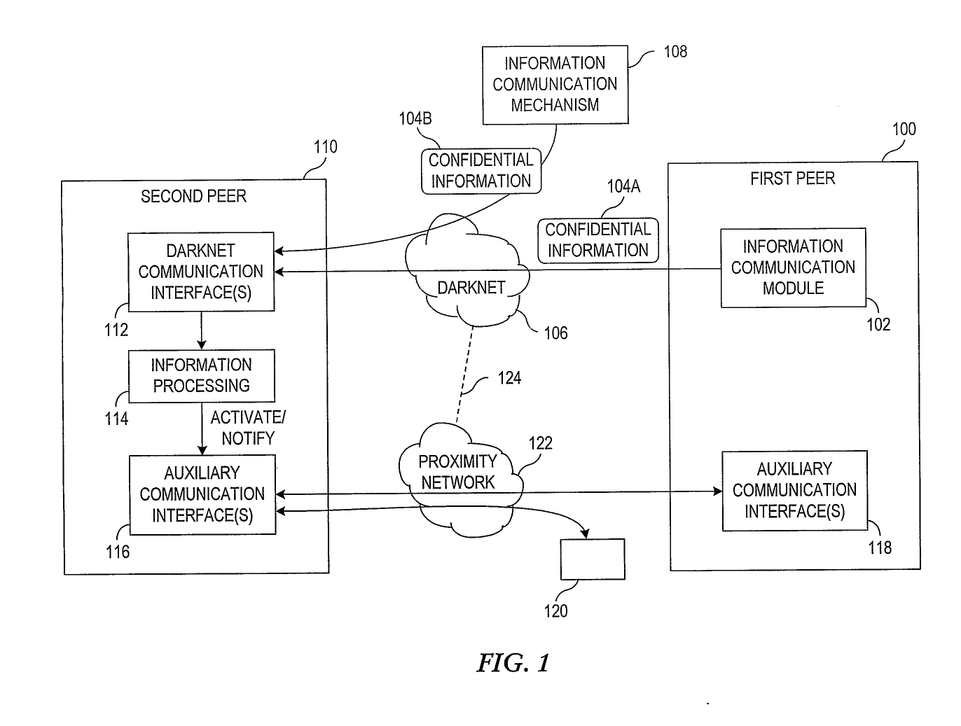

FIG. 1 is a block diagram illustrating an exemplary embodiment for providing darknet-assisted initiation of auxiliary network communications in accordance with the present invention. In accordance with the invention, one or more proximity or other auxiliary modes of networking may be initiated in response to information passed via a darknet. In the exemplary embodiment of FIG. 1, a first peer device 100 may include an information communication module 102 to communicate information, such as confidential information 104A, via a darknet 106. In this embodiment, the first peer 100 may use any conventional manner of transmitting the information 104A, such as cellular communications, messaging technologies such as Short Message Service (SMS) or Multimedia Messaging Service (MMS), signaling technologies such as the Session Initiation Protocol (SIP), or the like. Other manners of providing such information 104B via the darknet may also be utilized, which may be provided by an information communication mechanism 108 that is not integral with and/or otherwise associated with the first peer 100 device. For example, the information 104B may be communicated manually, or may be provided by a device other than the device associated with the first peer 100. Thus, the information 104A/104B may be communicated from the first peer 100 to one or more second peers 110 via the darknet 106 in any known manner.

In one embodiment, the information 104A/104B is transmitted electronically and confidentially in a peer-to-peer network embodiment of the darknet 106. In such case, the members communicate the information 104A/104B confidentially. For example, the members may establish secure tunnels between peers via a secure protocol(s) such as Internet Protocol (IP) Security, more commonly known as “IPsec.” IPsec generally refers to a set of protocols that support the secure exchange of packets at the IP layer. Another example of confidential communications that may be performed involves the members of the darknet having secure access to some shared resource, such as a virtual private network or other similar resource, again where secure communication protocols are employed. These or any other known manners of confidentially sharing information may be used to communicate the confidential information 104A/104B. In any event, the darknet nodes, represented in FIG. 1 as the peer devices 100, 110, are reachable with respect to one another, and each follow the rules of the particular peer-to-peer protocol.

The second peer 110 may receive the information 104A/104B via a darknet communication interface(s) 112, which represents any receiver or transceiver configured to receive the particular type of information 104A/104B. The information may also be received manually by the second peer 110 user, and entered into the device. It is assumed for purposes of the illustrated example that at least the second peer 110 (and possibly others) has decided to participate in a darknet 106. The members of the darknet share information 104A/104B such as, for example, information regarding their location, the available resources (e.g., remaining battery life, connection speed for infrastructure-based communications, etc.), terminal capabilities, and/or other information with other members of the darknet 106. Due to the information 104A/104B being communicated via a darknet 106, the information may be hidden from other parties, including the mobile network operator.

Using the information 104A/104B distributed over the darknet 106 between members 100, 110, the second peer 110 can process the information via the information processing module 114. This processing retrieves the relevant information from the particular message(s), packet(s), or other communication format, in order to identify the relevant information such as location, available resources, terminal capabilities and/or other information. The information processing 114 further determines, from at least a portion of this received information, when to attempt to form an ad-hoc network or an ad-hoc network stub. This determination may be made based on, for example, an examination of the location information and darknet member list. More particularly, addresses of darknet terminals that can be perceived or “heard” may be checked against the member list of the darknet. As another example, darknet members may made arrangements to take actions to attempt to establish direct connections.

When the particular darknet node (i.e. second peer 110) determines from the information that there is a possibility of forming a proximity ad-hoc network or a multi-hop ad-hoc network, the signaling to establish the ad-hoc network is automatically initiated. For example, based on the information, the second peer 110 may activate or otherwise enable for communication one or more auxiliary communication interfaces 116. By way of such auxiliary communication interface 116 in the second device, and a corresponding auxiliary communication interface 118 in the first device (and possibly other devices 120), the devices 100, 110 may communicate via a proximity network 122. The ad-hoc network 122 may be formed using any desired proximity network methodology, such as Wireless Local Area Networks (WLANs), Bluetooth, or other communication technologies that exhibit short-range, low-power, and/or infrastructure-less communication characteristics.

In this manner, an ad-hoc or multi-hop ad-hoc network 122 may be formed, where the signaling to establish the network 122 is automatically initiated. If successful, the ad-hoc network (shown as the proximity network 122) is formed and is taken into account when routing packets in the darknet. The proximity network 122 may thus form a part or new extension of the darknet 106, as depicted by dashed line 124. It should be noted that the auxiliary communication interface 116 can connect to a mesh of radio interfaces, enabling multi-hop communication between the peers 100, 110, where the communication is transmitted over multiple hops and one or more types of radio interfaces.

The information 104A/104B to initiate the communications via the auxiliary communication interfaces 116, 118 may be instigated by an action of the user of the first peer device 100, or automatically by a program on the device 100. For example, a user may initiate transfer of the information 104A via a user interface (UI) available on the device 100. Such user interface may include, for example, text entry, graphical user interface (GUI), device buttons or other mechanical selectors, voice commands, touch screen, etc. In another embodiment, particular triggering events may cause a program(s) on the first peer device 100 to automatically send the information to one or more second peer devices 110. For example, invoking a particular program on the first peer device 100 may automatically communicate the information 104A.

Any other defined triggering event may similarly cause automatic communication of the information, such as a particular time, date, location of the first peer 100 and/or second peer 110, user action on the first peer 100, etc. Similarly, activity at the second peer 110 to engage in communication via the auxiliary communication interface(s) 116 may be initiated automatically by a program on the second peer device 110, or manually by the user of the second peer device 110. For example, the second peer device 110 user may be notified that a request for auxiliary communication is desired, and the user may then manually activate the auxiliary communication interface(s) or the auxiliary communication interface(s) may be automatically invoked.

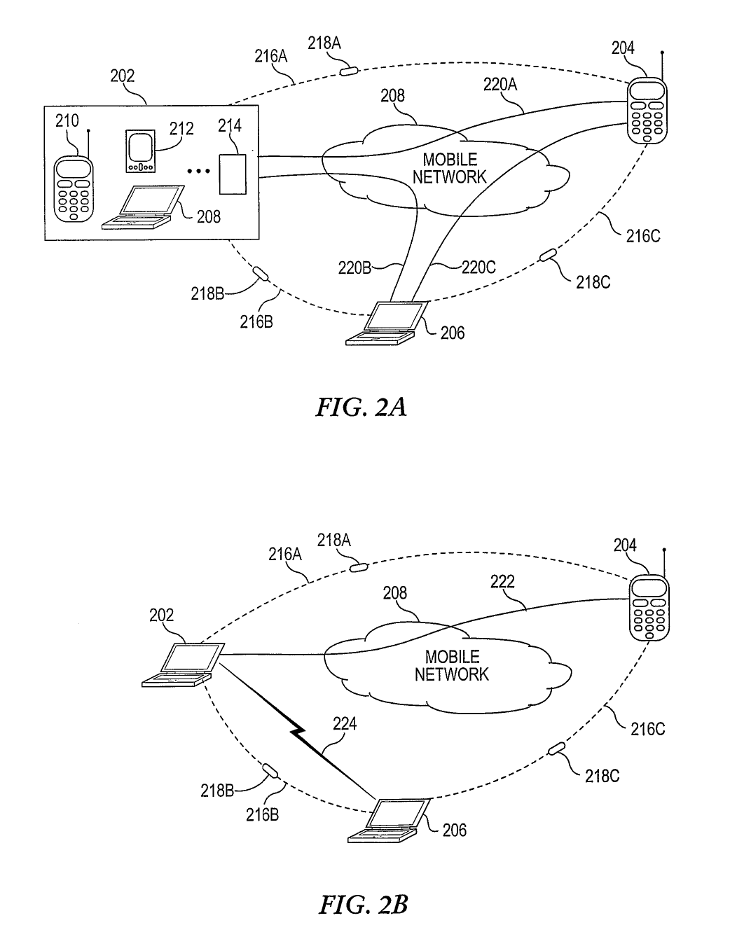

In reference now to FIG. 2A, an example arrangement of darknet nodes are illustrated according to embodiments of the present invention. In this arrangement, three peer devices 202, 204, 206 are capable of communicating via a mobile network 208. The mobile network 208 may include any combination of currently known or future network(s), such as Global System for Mobile communication (GSM), Personal Communications Services (PCS), Code Division Multiple Access (CDMA), Time Division Multiple Access (TDMA), etc.

The peer devices 202, 204, 206 may include any data processing arrangement known in the art. As shown relative to device 102, such devices may include a laptop 208, a cell phone 210, a PDA 212, or any other device as represented by generic device 214. The use of darknet to form ad-hoc proximity networks is independent of the type of hardware or software used in the devices 202, 204, 206. Generally, the peer devices 202, 204, 206 are connected to the edges of a darknet, represented by edges 216A-C. The darknet edges 216A-C provide member-based communications between the peer devices 202, 204, 206. The darknet communications may be carried over any combination of networks accessible by the devices, including the mobile network 208. The edges of the darknet may be used to communicate confidential information objects 218A-C between devices 202, 204, 206. In particular, these information objects 218A-C are used to initiate ad-hoc data transfers sessions via the mobile network 208.

The confidential information objects 218A-C may include any combination of binary and textual data used to contact devices having membership on a darknet. The objects 218A-C may include discrete collections of data (e.g., files, documents) or portions of continuously transmitted data (e.g., streams, signals). The confidential information objects 218A-C may include information regarding the peer devices that may be used to initiate data sessions. Such peer information may describe terminal addresses, terminal geographical location, timing information, radio technology descriptions, parameters affecting auxiliary interfaces, timeout values, security/authentication parameters, etc. Generally, the users of the devices 202, 204, 206 will keep one or more persistent connections open to receive the confidential information objects 218A-C over the darknet edges 216A-C. This allows the users of the devices 202, 204, 206 to be asynchronously informed of any requests to form an ad-hoc network. Upon receipt of confidential information objects 218A-C, the devices 202, 204, 206 may automatically (or at the discretion of the user) establish an ad-hoc network, as indicated by data paths 220A-C that are associated with the mobile network 208.

Once established, the data paths 220A-C allow devices 202, 204, 206 to perform ad-hoc data transfer interactions. In the arrangement illustrated in FIG. 2A, the devices 202, 204, 206 each have an independent path to the other devices 202, 204, 206 via the ad-hoc network. This allows any two of the devices 202, 204, 206 to continue communicating even if the third devices disconnects from the mobile network 208. It will be appreciated that the topology of the ad-hoc network may be hidden from the end user. The devices 202, 204, 206 may instantiate the illustrated ad-hoc data links 220A-C based on any criteria, such as network bandwidth, reliability/availability, available protocols, user preferences, device capability, etc. The data links 220A-C may also be used to expand the coverage of the darknet, such that the data links 220A-C complement the existing darknet edges 216A-C.

An alternate configuration of darknet nodes according to embodiments of the present invention is shown in FIG. 2B. Similar to FIG. 2A, three devices 202, 204, 206 are coupled via darknet edges 216A-C which are used to communicate respective confidential information objects 218A-C. In this example, only devices 202 and 204 are arranged to communicate via the mobile network 208, as indicated by path 222. The device 206 is joined directly to device 202 via an ad hoc “stub,” as indicated by path 224. In one configuration, the ad-hoc stub 224 may make device 206 invisible to all but directly connected device 202. In this configuration, the stubbed device 206 may still participate as a full member of the ad-hoc network, assuming device 202 is configured to act as a proxy or gateway for device 206. In other configurations, the device 202 may allow device 206 to be visible to other members of the mobile network, such that the device 202 acts as a router for device 206. It will be appreciated that the ad-hoc networks may be formed using any combination of broadcast or stubbed network topologies.

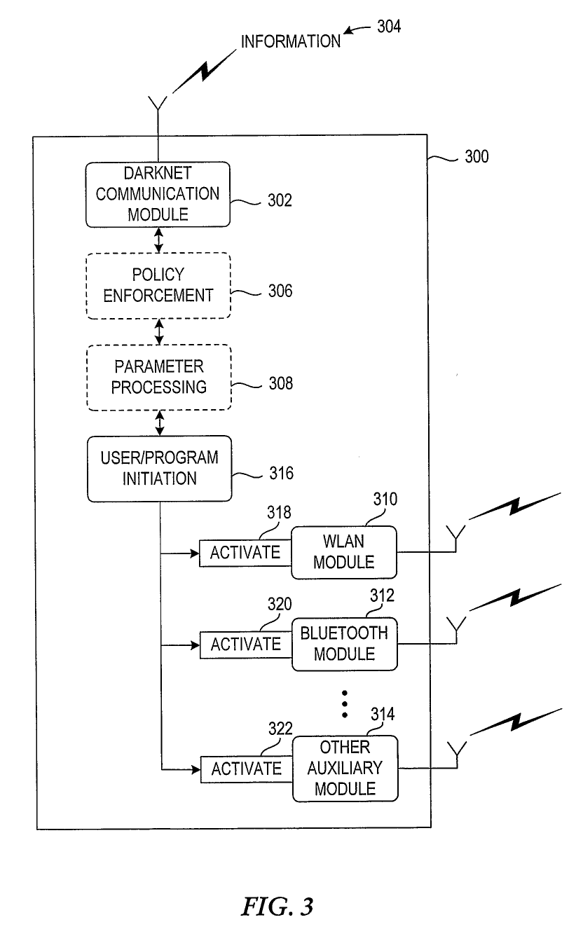

As previously described, any computing device known in the art may used to initiate ad-hoc networks via darknet communications. One example of such a device 300 according to embodiments of the present invention is shown in FIG. 3. The device 300 represents a wireless communication device, such as a mobile phone, Personal Digital Assistant (PDA), wireless computing device, or other device/communicator capable of communicating via wireless networks and/or interfaces. The device 300 may also represent a fixed wireless device, such as a computing system or other communicator in a fixed location and deriving electrical power from fixed utility sources, yet having wireless communication capabilities such as cellular communication capabilities and WLAN/Bluetooth capabilities.

The mobile device 300 includes a first communication interface module, shown in FIG. 3 as the darknet communication module 302. The module 302 represents a radio communication interface, such as a cellular radio interface. In one arrangement, this darknet communication interface 302 may refer to a radio interface or mode of operation of a radio interface that is normally maintained in an “on” state when the device 300 itself is powered on, so that communications may be received at any time. In one embodiment, this darknet interface(s) may referred to as the “default” radio communication interface, as it serves as a default means of communication. The default radio communication module 302 may include the hardware and/or software required to carry out such communications. For example, the mobile device 300 may be equipped with a processor, transceiver, program instructions, and the like to carry out the desired communications.

In accordance with one embodiment of the present invention, one or more information objects 304 are received at the mobile device 300 at the darknet communication module 302. These messages 304 may be provided in any number of available manners, such as via layer-2 framing such as Wireless Ethernet or Bluetooth MAC, GPRS PDP messages, IP packets or included in an IP packet as an IP option, an SMS message, or any other form of message exchange being utilized between the communicating peers. The darknet communication module provides membership such that the user may communicate via the darknet with the communications retaining some amount of confidentiality and/or anonymity relative to entities outside the darknet. In particular, the message(s) 304 are only accessible by those users currently connected to the darknet, and it is these users that seek to gain benefit by forming additional ad-hoc networks.

Upon receiving the message(s) 304 in accordance with one embodiment, the device 300 may optionally enforce policies via the policy enforcement module 306. Such policies may provide guidelines for action by the device 300 depending on the instructions provided via the message(s) 304. For example, assume the instructions provided via a message 304 request the device 300 to start an auxiliary communication interface to engage in proximity networking with one or more other devices. The device 300 may include policies to prohibit such auxiliary radio communications if certain conditions are/are not met, and/or the device 300 is not compatible with the capabilities required for the auxiliary mode of operation as communicated by the initiating peer.

In such cases, the policy enforcement module 306 can apply the established policies to continue communicating via the default radio communication module 302. For example, a policy may be in place that indicates that a real-time gaming session is continued only if an auxiliary radio interface utilizing an infrastructure-less mode of operation can be utilized, such as communication via WLAN or Bluetooth. As another example, a policy may indicate that transmission of a message including one or more images is continued over the default radio interface if an auxiliary mode cannot be opened. Yet another exemplary policy may be to automatically communicate via a WLAN with the initiating peer and/or other devices whenever the instructions of the message request WLAN communication. Any desired policies may be implemented via such a policy enforcement module 306.

In accordance with one embodiment of the invention, parameters may be exchanged between the peers as part of the message exchange to initiate the auxiliary mode of operation. These parameters may include, for example, addressing information of the peers, location information, timing information, radio technology identification, auxiliary mode attributes, timeout values, security/authentication parameters, etc. Such parameters may be processed via the parameter processing module 308.

Based on the information provided via the message(s) 304, one or more resident auxiliary radio communication modules 310, 312, 314 may be activated. Such an attempt to activate one or more auxiliary radio communication modules may be initiated by the user of the device 300, or initiated via a program in response to a triggering event such as receipt of the message 304. This is depicted via the user/program initiation block 316. Depending on the information provided via the message(s) 304, and optionally depending on particular policies and/or parameters, one or more of the auxiliary radio communication modules 310, 312, 314 may be activated for communication. For example, a message 304 may request the device 300 to communicate with the initiating peer via a Wireless Local Area Network (WLAN), in which case the WLAN module 310 may be activated.

In one embodiment, activation of an auxiliary communications module involves enabling power to the WLAN module 310 via a power enable module/circuit, depicted as the activate module 318. As a more particular example, the information associated with the message 304 may cause an activate circuit 318 to apply power to the WLAN module 310, and to configure the WLAN module 310 for communication with the initiating peer and/or other devices via the WLAN. By powering on the WLAN module 310, the device 300 can be configured to listen for incoming communications via the WLAN, and/or may initiate WLAN communications itself. In this manner, energy is not wasted by continuously providing power to the WLAN module 310 until such time that communications via the WLAN is requested or otherwise desired. In another embodiment, the WLAN module 310 may be “powered on” to some extent, but not fully powered to enable communication. In such a case, activation of the module involves “enabling for communication” the WLAN module 310, such as by powering on the relevant portion(s) of the WLAN module 310 required to engage in the auxiliary communication.

The device 300 may include one or more auxiliary radio communication interfaces. Another exemplary auxiliary radio communication module depicted in FIG. 3 is a Bluetooth module 312. If communications via Bluetooth is desired, the Bluetooth module 312 may be activated 320 in a manner analogous to that described above. Any other short-range radio interface, and/or infrastructure-less radio interface, and/or peer-to-peer radio interface, or the like may be employed, as depicted by auxiliary module 314. Such a module 314 is activated 322 when the message(s) 304 identify the particular auxiliary radio interface as the designated or preferred communication means, as previously described. The auxiliary module 314 may also be identified based on, for example, addressing information if not otherwise explicitly identified.

As can be seen from the foregoing example, infrastructure-less or proximity (e.g., peer-to-peer) communications can be initiated only when needed/desired, without having to continually provide power to such auxiliary radio interfaces, or at least without having to keep all parts of the auxiliary radio interfaces powered on. Keeping such additional radio interfaces perpetually prepared for incoming connections wastes energy when the respective additional radio interface is not being used for active communications. Thus, in accordance with one embodiment of the invention, the auxiliary radio interface(s) or communication modes (or particular portions related to the communication) may be switched on when ready for active use, and otherwise be switched off to conserve energy. Further, providing such control over auxiliary radio communications allows communications to be diverted from an infrastructure-based radio communication interface (e.g., cellular network) to an infrastructure-less or peer-to-peer network (e.g., WLAN, Bluetooth, etc.) when desired, which can conserve on infrastructure-based network usage which may be more costly, less responsive or reliable due to network congestion and/or signal strength, and/or which may allow the infrastructure-based network to serve more customers.

The message(s) to initiate the auxiliary radio interface(s) at the target device may therefore utilize the infrastructure and addressing capabilities of a darknet communications interface to initially address the peer, and to perform the message exchange with the peer. This message exchange may involve the exchange of various parameters, as previously described. These parameters may include, for example, addressing information of the peers, location information, timing information, radio technology identification information, auxiliary mode attributes, timeout values, security/authentication information, and the like.

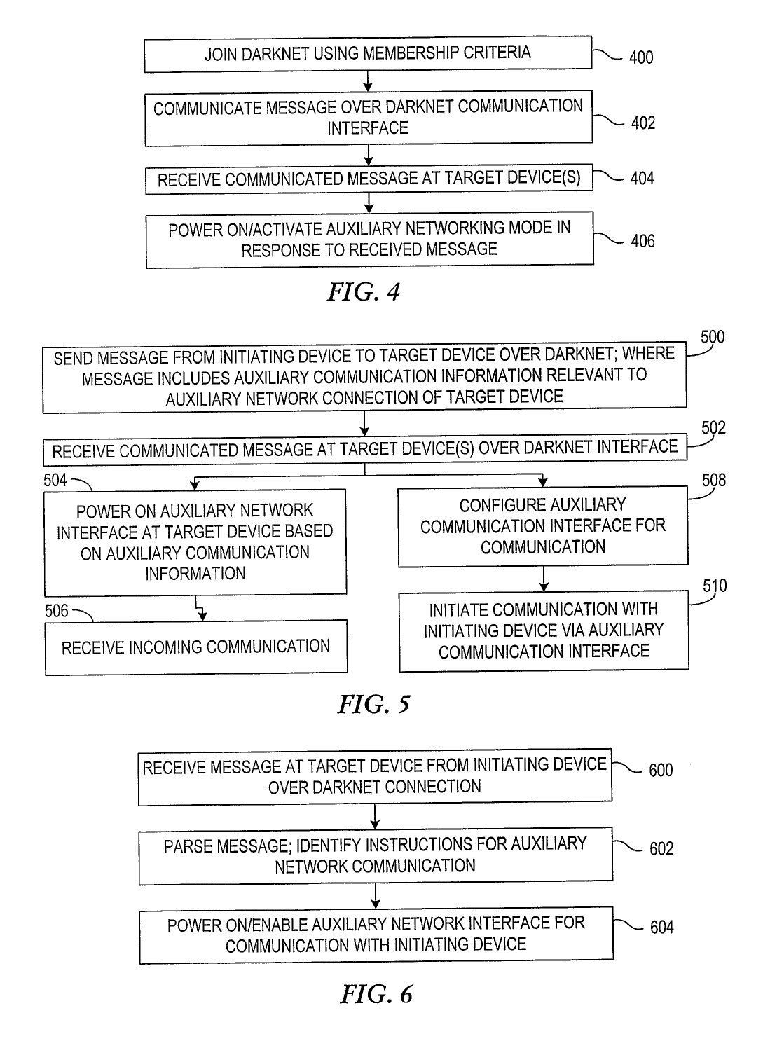

The message exchange using a primary/default radio communication interface therefore enables proximity networking or other auxiliary networking mode to be initiated when needed, without the auxiliary radio interface continuously being on—e.g., in a listening mode or otherwise ready to receive communications via the proximity or other auxiliary networking mode. Using the present invention, auxiliary radio communications may be initiated when needed, using a radio communication interface that is already prepared to receive communications. This aspect of the invention is generally illustrated in FIG. 4, which illustrates a flow diagram of a method for initiating proximity or auxiliary networking communications via a darknet and/or membership restricted connection. The members first join 400 the darknet using the appropriate membership criteria. One or more messages are communicated 402 over the darknet communication interface, such as a peer-to-peer network operated over a cellular connection. The message is received 404 at one or more target devices, and the auxiliary networking mode at the target device(s) is powered on or otherwise activated in response to the received message as shown at block 406.

FIG. 5 illustrates another method for initiating auxiliary radio communications via a darknet communications interface. In the illustrated embodiment, one or more messages are sent 500 from an initiating device to one or more target devices over a darknet, where the message includes auxiliary communication information relevant to establishing an auxiliary network connection at the target device. The message(s) is received 502 at the target device(s) over the darknet interface(s). In one embodiment illustrated at block 504, at least one auxiliary network interface is powered on or otherwise enabled for communication at the target device, based on the auxiliary communication information provided via the cellular network. Once powered on, the target device (or the relevant communication circuitry) stands prepared to receive 506 incoming communications via the enabled auxiliary communication interface. In another embodiment, the message(s) received 502 at the target device may result in the identified auxiliary radio communication interface at the target device being configured 508 for communication, where the target device may then initiate 510 communication with the initiating device (and/or other devices) via the identified auxiliary radio communication interface.

In accordance with one embodiment, messages are received at the target device from the initiating device over a darknet connection, as shown at block 600 of FIG. 6. The target device may parse 602 the message to identify the instructions for performing auxiliary network communication. The auxiliary network interface at the target device is powered on or otherwise enabled for communication with the initiating device, as shown at block 604.

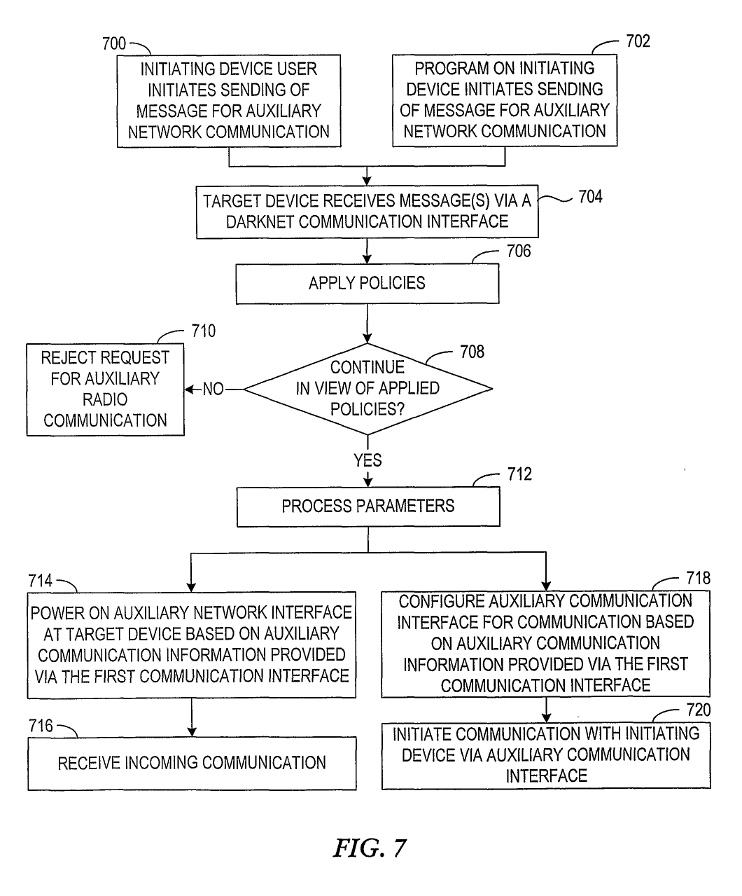

FIG. 7 illustrates yet another embodiment of a method for initiating auxiliary radio communications via a darknet interface in accordance with the principles of the present invention. The user of the initiating device may initiate 700 sending of a message(s) to engage in communication via a darknet interface. Alternatively, a program on the initiating device may automatically initiate 702 sending of the message(s) for darknet communication. One or more target devices receive 704 the message(s) via a darknet communication interface, such as a cellular network interface. Policies may optionally be applied 706 at the target device(s), such that decisions based on such policies can be made to determine whether or how such auxiliary network communications will be effected. If it is determined 708 that auxiliary network communications will not be conducted, the request for auxiliary radio communication will be rejected 710. Otherwise, the process continues, where parameters associated with the message(s) may be exchanged and processed as shown at block 712. In one embodiment, at least one auxiliary network interface is powered on 714 at the target device, based on the auxiliary communication information provided via the first communication interface. When the auxiliary communication interface has been powered on, the target device stands prepared to receive 716 incoming communications via the enabled auxiliary communication interface. In another embodiment, the message(s) received at the target device result in the identified auxiliary radio communication interface at the target device being configured 718 for communication, based on the information provided via the first communication interface. The target device may then initiate 720 communication with the initiating device (and/or other devices) via the identified auxiliary radio communication interface.

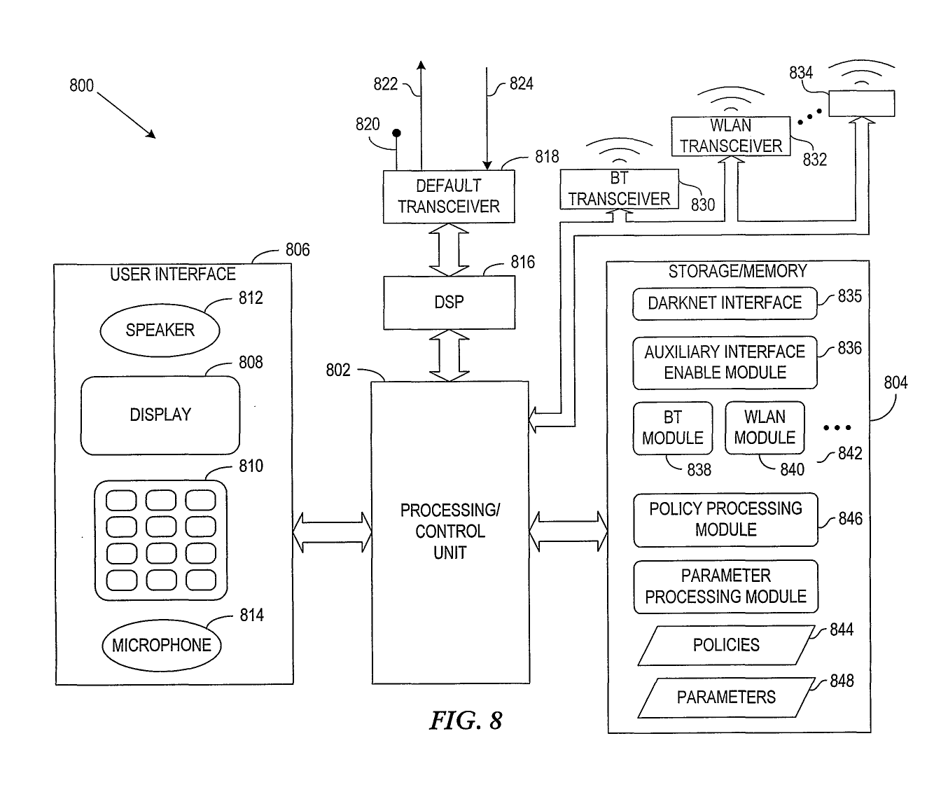

Hardware, firmware, software or a combination thereof may be used to perform the functions and operations at the mobile devices in accordance with the invention. The mobile devices in accordance with the invention include communication devices capable of engaging in at least one default radio connection, and at least one auxiliary radio connection. These devices include, for example, mobile phones, PDAs, and other wireless communication devices, as well as landline computing systems and communication systems also capable of over-the-air (OTA) communication. A representative example of a mobile device employing principles of the present invention is illustrated in FIG. 8.

The representative mobile device 800 utilizes computing circuitry to control and manage the conventional device activity as well as the functionality provided by the present invention. For example, the illustrated mobile device 800 includes a processing/control unit 802, such as a microprocessor, reduced instruction set computer (RISC), or other central processing module. The processing unit 802 need not be a single device, and may include one or more processors. For example, the processing unit may include a master processor and associated slave processors coupled to communicate with the master processor.

The processing unit 802 controls the basic functions of the mobile device 800 as dictated by programs available in the program storage/memory 804. The storage/memory 804 may include an operating system and various program and data modules associated with the present invention. In one embodiment of the invention, the programs are stored in non-volatile electrically-erasable, programmable read-only memory (EEPROM), flash ROM, etc., so that the programs are not lost upon power down of the mobile device. The storage 804 may also include one or more of other types of read-only memory (ROM) and programmable and/or erasable ROM, random access memory (RAM), subscriber interface module (SIM), wireless interface module (WIM), smart card, or other fixed or removable memory device. The relevant software for carrying out mobile device operations in accordance with the present invention may also be transmitted to the mobile device 800 via data signals, such as being downloaded electronically via one or more networks, such as the Internet and an intermediate wireless network(s).

For performing other standard mobile device functions, the processor 802 is also coupled to user-interface 806 associated with the mobile device 800. The user-interface (UI) 806 may include, for example, a display 808 such as a liquid crystal display, a keypad 810, speaker 812, and microphone 814. These and other UI components are coupled to the processor 802 as is known in the art. The keypad 810 may include alpha-numeric keys for performing a variety of functions, including dialing numbers for conventional, default cellular communication, and/or effecting auxiliary radio communication. Other UI mechanisms may be employed, such as voice commands, switches, touch pad/screen, graphical user interface using a pointing device, trackball, joystick, or any other user interface mechanism.

The wireless device 800 may also include conventional circuitry for performing wireless transmissions over the mobile network. The DSP 816 may be employed to perform a variety of functions, including analog-to-digital (A/D) conversion, digital-to-analog (D/A) conversion, speech coding/decoding, encryption/decryption, error detection and correction, bit stream translation, filtering, etc. The default transceiver 818, generally coupled to an antenna 820, transmits the outgoing radio signals 822 and receives the incoming radio signals 824 associated with the mobile device 800. For example, signals 822, 824 may represent the message exchange to initiate auxiliary radio communication in accordance with the present invention. This message exchange may be conducted via a Radio Access Network (RAN) associated with a cellular network, such as Global System for Mobile communications (GSM), Universal Mobile Telecommunications System (UMTS), Personal Communications Service (PCS), Time Division Multiple Access (TDMA), Code Division Multiple Access (CDMA), or other mobile network transmission technology.

In accordance with the present invention, the communicating mobile devices include at least one auxiliary radio communication interface that may operate separately or in conjunction with a darknet interface 835. The illustrated embodiment includes a Bluetooth transceiver 830 for communicating via Bluetooth standards. A wireless LAN (WLAN) transceiver 832 provides for wireless communication via a local wireless network, such as in accordance with IEEE 802 standards. Any other auxiliary radio communication interface may instead, or in addition, be used in accordance with the present invention, as depicted by the respective transceiver 834.

It should be noted that any of the transceivers illustrated in FIG. 8 may be implemented as a modular transceiver including both transmitting and receiving circuitry, or any of such transceivers may alternatively be implemented as discrete transmitter and receiver circuits. As used herein, a “transceiver” is intended to describe circuits or other modules for wirelessly transmitting and receiving information, regardless of whether the transmitter and receiver circuits are discrete components or collectively provided in a single package.

In the illustrated embodiment, the storage/memory 804 stores the various client programs and data associated with the present invention. For example, the storage 804 includes an auxiliary interface enable module 836, which may include program instructions for enabling power to a particular one or more of the auxiliary radio communication interfaces. For example, a message received via the darknet interface 835 may identify Bluetooth as the desired auxiliary radio interface. The auxiliary interface enable module 836 recognizes that Bluetooth is the desired auxiliary radio interface, and together with the processing unit 802 may power on, or otherwise enable for communication, the Bluetooth-related circuitry such as the Bluetooth transceiver 830 to enable its operation. It should be recognized that additional hardware (not shown) to enable power to such transceivers 830, 832, 834 may also be implemented.

In addition to the various transceiver circuits 830, 832, 834, associated software modules may be provided to assist in the operation of the particular auxiliary radio communication methodology employed. For example, where Bluetooth is the desired auxiliary radio interface, a Bluetooth program module 838 may include software operable via the processing unit 802 and operable to communicate information via the Bluetooth transceiver 830. Similarly, a WLAN module 840 may include program instructions operable via the processing unit 802 and operable to communication information via the WLAN transceiver 832. The storage/memory 804 may also include a policy processing module 842 for processing policies 844. A parameter processing module 846 may be provided to process parameters 848 that may be received via the messages and/or stored at the storage/memory 804.

As previously indicated, the auxiliary communication information may be sent from one communication device to another communication device(s) via a darknet communication interface 835. The darknet interface 835 may be configured to connect to a darknet over any interface hardware of the mobile device 800. This includes, for example, sending the darknet information via a GSM/GPRS, TDMA, CDMA, PCS, or any other cellular network infrastructure. The darknet interface 835 may utilize any known or future networking technologies that provide confidentiality and/or anonymous messaging and signaling, including Freenet, Gnutella, Mnemsoyne, Napster, virtual private networks, secure sockets layer, etc., and any combination thereof. When communicating via the darknet, the information traverses the network, and involves one or more network elements or intermediaries. For example, an auxiliary radio communication initiation message(s) may be communicated between GPRS Support Nodes (GSNs), such as between GGSNs and/or SGSNs, using a GPRS Packet Data Protocol (PDP) message(s) where a GPRS network is employed. Or, the auxiliary information may be included in user data packets carried by way of the GPRS Tunneling Protocol (GTP), IP packets, and the like.

The foregoing description of the exemplary embodiment of the invention has been presented for the purposes of illustration and description. It is not intended to be exhaustive or to limit the invention to the precise form disclosed. Many modifications and variations are possible in light of the above teaching. For example, any combination of existing or future membership-based networking technologies may be used to effect darknet communications as described herein. It is intended that the scope of the invention be limited not with this detailed description, but rather determined by the claims appended hereto.

What is claimed is:

1. A method for communicating between devices, comprising:
communicating auxiliary communication information from at least one initiating device to at least one target device via a membership-based communication interface; and
in response to the auxiliary communication information, activating an auxiliary communication module at the at least one target device for communication via a second over-the-air (OTA) communication interface.

2. The method of claim 1, further comprising the target device communicating via the second OTA communication interface.

3. The method of claim 2, wherein the target device communicating via the second OTA communication interface comprises the target device communicating with at least the initiating device via the second OTA communication interface.

4. The method of claim 2, wherein the target device communicating via the second OTA communication interface comprises the target device communicating with at least one device different than the initiating device.

5. The method of claim 1, wherein communicating auxiliary communication information from at least one initiating device to at least one target device via the membership-based communication interface comprises transmitting the auxiliary communication information from the at least one initiating device to at least one target device via a cellular network.

6. The method of claim 1, wherein the first OTA communication interface comprises a default interface available for communication at any time that the initiating and target devices are powered on.

7. The method of claim 1, wherein communicating auxiliary communication information from at least one initiating device to at least one target device via the membership-based communication interface comprises transmitting at least information instructing the target device to enable the auxiliary communication module for communication at the target device.

8. The method of claim 1, wherein communicating auxiliary communication information from at least one initiating device to at least one target device via the membership-based communication interface comprises transmitting at least information inviting the target device to enable for communication a plurality of auxiliary communication modules at the target device.

9. The method of claim 1, wherein communicating auxiliary communication information from at least one initiating device to at least one target device via the membership-based communication interface comprises transmitting at least information inviting the target device to initiate communications with the initiating device via the second OTA communication interface.

10. The method of claim 1, wherein the membership-based communication interface comprises a darknet interface.

11. The method of claim 1, wherein the second OTA communication interface comprises a proximity-based network interface.

12. The method of claim 1, wherein the second OTA communication interface comprises one or more wireless interfaces coupled to an ad-hoc network.

13. The method of claim 12, wherein communication via the one or more wireless interfaces coupled to the ad-hoc network comprises communication over multiple hops of the ad-hoc network using the one or more wireless interfaces.

14. The method of claim 1, wherein communicating auxiliary communication information from at least one initiating device to at least one target device via the membership-based communication interface comprises transmitting the auxiliary communication information from the initiating device to the at least one target device via one or more internet layer transmissions.

15. The method of claim 14, wherein the internet layer transmissions comprise Internet Protocol (IP) packet transmissions.

16. The method of claim 1, wherein communicating auxiliary communication information comprises transmitting auxiliary communication parameters for controlling communications over the second OTA communication interface.

17. The method of claim 16, wherein transmitting auxiliary communication parameters comprises transmitting address information of one or more of the initiating and target devices.

18. The method of claim 16, wherein transmitting auxiliary communication parameters comprises transmitting one or more of security and authentication information.

19. A method for facilitating network communications via a mobile device, comprising:
receiving at least one message at the mobile device via a membership-based communication interface, wherein the at least one message includes proximity communication information;
identifying the proximity communication information at the mobile device;
enabling at least one wireless proximity communication interface or at least one auxiliary mode of operation of the default radio interface in response to the identified proximity communication information; and
wirelessly communicating between the mobile device and at least one other communication device via the enabled wireless proximity communication interface.

20. The method of claim 19, wherein the membership-based communication interface comprises a darknet interface.

21. The method of claim 19, wherein receiving at least one message at the mobile device via the membership-based communication interface comprises receiving the at least one message via a cellular network.

22. The method of claim 19, wherein enabling at least one wireless proximity communication interface comprises applying power to a wireless proximity communication module associated with the wireless proximity communication interface.

23. The method of claim 19, wherein enabling at least one wireless proximity communication interface comprises initiating, at the mobile device, wireless communication with the at least one other communication device via the wireless proximity communication interface.

24. The method of claim 19, wherein wirelessly communicating comprises communicating over-the-air via at least one of a Wireless Local Area Network (WLAN) and a Bluetooth network.

25. A communication device for communicating over-the-air (OTA), comprising:
at least one default communication module configured for communication via a membership-based communication interface;
at least one auxiliary radio communication module capable of effecting wireless communication via a respective auxiliary radio communication interface; and
a processing module configured to receive auxiliary communication information via the membership-based communication interface, and to activate the auxiliary radio communication module identified by the auxiliary communication information for communication via the respective auxiliary radio communication interface.

26. The communication device of claim 25, wherein the processing module comprises an auxiliary interface enable module configured to enable the respective auxiliary radio communication interface for communication in response to the auxiliary communication information.

27. The communication device of claim 25, wherein the processing module comprises a parameter processing module configured to process parameters associated with the auxiliary communication information, and to configure the respective auxiliary radio communication interface based at least in part on the processed parameters.

28. The communication device of claim 25, wherein:
the at least one default communication module comprises a first receiver coupled OTA to an initiating device to receive at least the auxiliary communication information via the membership-based communication interface; and
the at least one auxiliary radio communication module comprises a transceiver for communicating via the auxiliary radio communication interface.

29. The communication device of claim 25, further comprising an activate circuit coupled to the processing module and to the auxiliary radio communication module, wherein the processing module is further configured to activate the auxiliary radio communication module identified by the auxiliary communication information by providing one or more signals to the activate circuit, and wherein the activate circuit provides battery power to the auxiliary radio communication module in response to the one or more signals.

30. The communication device of claim 25 wherein the communication device comprises any of a mobile phone, Personal Digital Assistant (PDA), wireless communication device, mobile computing system, and fixed wireless computing system.

31. The communication device of claim 25 wherein the communication device comprises a computing system capable of over-the-air (OTA) communication via the darknet communication interface and the radio communication interface.

32. A system for communicating information between devices, comprising:
an initiating communication device;
a recipient communication device coupled to communicate over a membership-based communications interface with the initiating communication device to receive auxiliary communication information from the initiating communication device, the recipient communication device comprising:
a first communication module configured for first communication via the membership-based communications interface;
at least one auxiliary communication mode capable of effecting second wireless communication; and
a processing module configured to receive the auxiliary communication information via the first communication module over the membership-based communications interface, and to activate the auxiliary communication mode identified by the auxiliary communication information for communication via the second wireless communication.

33. The system as in claim 32, wherein the at least one auxiliary communication mode comprises at least one auxiliary mode of operation capable of effecting the second wireless communication via the default OTA interface.

34. The system as in claim 32, wherein the at least one auxiliary communication mode comprises at least one auxiliary communication module capable of effecting the second wireless communication via a respective auxiliary OTA interface.

35. The system as in claim 34, wherein the processing module comprises an auxiliary interface enable module to apply power to the at least one auxiliary communication module in connection with the activation of the at least one auxiliary communication module.

36. The system as in claim 34, wherein the initiating communication device comprises:
a first initiating communication module configured for the first communication via the membership-based communications interface;
at least one initiating auxiliary communication module capable of effecting the second wireless communication via the respective auxiliary OTA interface; and
an auxiliary interface information generation module to generate the auxiliary communication information for transfer to the recipient communication device via the membership-based communications interface.

37. The system as in claim 32, wherein the recipient communication device comprises any of a mobile phone, handset communication device, fixed wireless communication device, Personal Digital Assistant (PDA) and portable computing device.

38. The system as in claim 32, wherein the initiating communication device comprises any of a mobile phone, handset communication device, fixed wireless communication device, Personal Digital Assistant (PDA) and portable computing device.

39. A computer-readable medium having instructions stored thereon which are executable by a computer system for enabling auxiliary radio communications via a communications device by performing steps comprising:
identifying proximity communication information associated with one or more messages received at the communications device via an infrastructure-based radio interface;
enabling a wireless proximity communication interface for over-the-air communication in response to the identified proximity communication information; and
facilitating wireless communications between the communications device and at least one other communication device via the wireless proximity communication interface.

40. A communication device capable of communicating over-the-air (OTA), comprising:
means for receiving auxiliary communication information at the communication device via a membership-based communications interface;
means for enabling at least one of an auxiliary communication interface or an auxiliary mode of operation of the membership-based communications interface at the communication device in response to the auxiliary communication information; and
means for communicating OTA between the communication device and at least one other communication device via an enabled one or more of the auxiliary communication interface or the auxiliary mode of operation of the default radio interface.

41. A network element operable in a network for facilitating communication between at least first and second communication devices, the network element comprising:
a receiver coupled to the first communication device via the network to receive auxiliary communication information from the first communication device according to a primary membership-based communication mode, wherein the auxiliary communication information represents an invitation from the first communication device targeted for the second communication device to activate an auxiliary OTA communication mode for communication therebetween; and
a transmitter coupled to the second communication device via the network to transmit the auxiliary communication information to the second communication device according to the primary membership-based communication mode, whereby the first and second communication devices are enabled for communication according to the auxiliary OTA communication mode in response to the second communication device receiving the auxiliary communication information.
